(19) United States
(12) Patent Application Publication
(10) Pub. No.: US 2026/0054479 A1
(43) Pub. Date: Feb. 26, 2026

(54) LIQUID EJECTION APPARATUS AND CONTROL METHOD

(71) Applicant: CANON KABUSHIKI KAISHA, Tokyo (JP)

(72) Inventors: YOSHIHIRO HAMADA, Kanagawa (JP); KEIJI TOMIZAWA, Kanagawa (JP); TAKATSUGU MORIYA, Tokyo (JP); FUMI TANAKA, Kanagawa (JP); KOICHI ISHIDA, Tokyo (JP); YUJI NUKUI, Kanagawa (JP); SHUZO IWANAGA, Kanagawa (JP); YUGO YAMAMOTO, Kanagawa (JP)

(21) Appl. No.: 19/289,466

(22) Filed: Aug. 4, 2025

(30) Foreign Application Priority Data
Aug. 21, 2024 (JP) 2024-140029

(51) Int. Cl. B41J 2/045; B41J 2/14; B41J 29/17

(52) U.S. Cl. CPC B41J 2/04513; B41J 2/0458; B41J 2/14072; B41J 2/14112; B41J 29/17

(57) ABSTRACT

Provided is a technique for achieving stable ejection characteristics. To this end, during liquid ejection, a potential difference ΔVa is generated between an electrode and an opposing electrode, the potential difference ΔVa being different between a liquid ejection head in a brand-new state and a liquid ejection head which has performed a kogation removal operation before.

### BACKGROUND

### Field of the Technology

The present disclosure relates to a liquid ejection apparatus and a method for controlling the same.

### Description of the Related Art

A printing apparatus configured to eject liquid such as ink from a liquid ejection head may employ, as a method for generating energy to eject the liquid, an ejection method which heats ink using heat-generating resistors (hereinafter also referred to as “heaters”) and thereby forms bubbles in the ink. In such a method where ink is ejected by being heated by heaters, the heating of the ink by the heaters may cause the ink to be burnt and stuck onto the surface of the heaters, resulting in a change in the ink ejection speed.

A colorant in ink used in such a printing apparatus is often dye-based or pigment-based and is often insoluble or poorly soluble in water. Such an insoluble or poorly soluble colorant is a possible cause of the burning and sticking (what is called kogation).

In a case where such an ink that easily burns and sticks is ejected with almost no kogation present on the surface of a heater, kogation is formed on the kogation-free heater surface. This is known to change how heat is transmitted to the ink and consequently change the ejection characteristics (lower the speed of ejection).

Japanese Patent Laid-Open No. 2019-038127 proposes a liquid ejection apparatus having first and second electrodes disposed so as to generate an electric field in a liquid chamber in a liquid ejection head. The electric field generated in a liquid chamber moves charged particles, which can be a cause of kogation, away from the heater surface, making it less likely for kogation to be formed on a liquid ejection head substrate during ejection. The liquid ejection head substrate can thus be improved in durability.

Also, as a method for removing kogation on a heater, a process is known which removes kogation by causing electrochemical reaction with ink to dissolve the heater surface (hereinafter referred to as a kogation removal process). However, for example, the state of the superficial layer is not the same between the heater surface at the start of the usage of the liquid ejection head and the heater surface having undergone the kogation removal process. Thus, in a case where, as in Japanese Patent Laid-Open No. 2019-038127, kogation formation is reduced through ejection performed under the same conditions without consideration for the state of the liquid ejection head, ejection characteristics may change anyway.

### SUMMARY

Thus, the present disclosure provides a technique which allows stable ejection characteristics to be achieved regardless of the state of a liquid ejection head.

To that end, a liquid ejection apparatus of the present disclosure is a liquid ejection apparatus to which an ejection unit is attachable, the ejection unit having a heat generating resistor configured to generate energy for ejecting liquid by generating heat upon energization, a first electrode provided at a protection part covering and protecting the heat generating resistor, and a second electrode capable of being electrically conductive to the first electrode via the liquid. The liquid ejection apparatus includes a control unit configured to control the ejection unit attached to the liquid ejection apparatus. By applying voltage between the first electrode and the second electrode, the control unit is capable of executing a kogation removal process for removing deposited kogation by dissolving a surface of the first electrode into the liquid, and while the ejection unit performs a liquid ejection operation, the control unit generates a potential difference between the first electrode and the second electrode, the potential difference being different between a case where the ejection unit has performed the kogation removal process before and a case where the ejection unit has not performed the kogation removal process before.

The present disclosure can provide a technique which allows stable ejection characteristics to be achieved.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing a schematic configuration of a liquid ejection apparatus;

FIG. 2 is a block diagram showing the configuration of the liquid ejection apparatus;

FIG. 3 is a schematic diagram showing a first circulation path as a first mode of a circulation path;

FIG. 4 is a schematic diagram showing a second circulation path;

FIGS. 5A and 5B are perspective views of a liquid ejection head;

FIG. 6 is an exploded perspective view of components and units constituting the liquid ejection head;

FIGS. 7A, 7B, 7C, 7D, 7E, and 7F are diagrams showing the front and back surfaces of each of first to third flow channel members;

FIG. 8 is a see-through view as seen from the surface of the first flow channel member where ejection modules are installed;

FIG. 9 is a diagram showing a section taken along the line IX-IX in FIG. 8;

FIGS. 10A and 10B are perspective views of the ejection module;

FIGS. 11A, 11B, and 11C are plan views of a print element substrate;

FIG. 12 is a perspective view showing a section of the print element substrate and a lid member;

FIG. 13 is a plan view showing a close-up of a part where the print element substrates are adjacent to each other;

FIGS. 14A and 14B are diagrams showing an area around a heat action portion in the print element substrate;

FIGS. 15A, 15B, and 15C are schematic views showing a kogation reduction process for negatively charged particles;

FIG. 16 is a graph showing the relation between an ejection speed and a potential difference; and

FIGS. 17A and 17B are schematic diagrams showing a kogation reduction process for positively charged particles.

### DESCRIPTION OF THE EMBODIMENTS

### First Embodiment

A first embodiment of the present disclosure is described below with reference to the drawings.

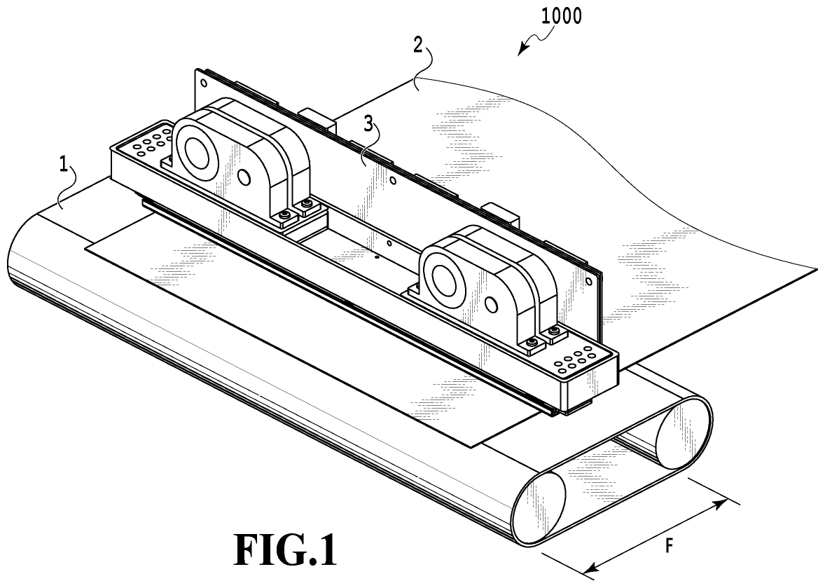

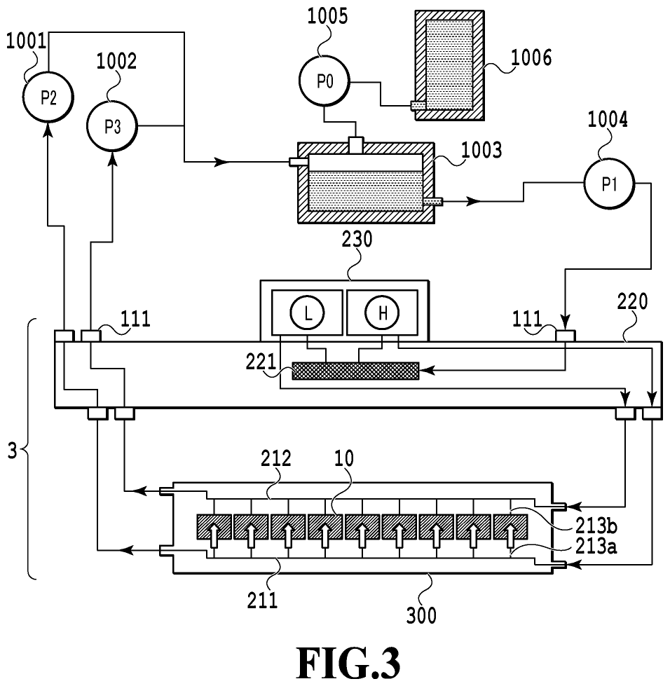

FIG. 1 is a diagram showing a schematic configuration of a liquid ejection apparatus (hereinafter also referred to as a printing apparatus) 1000 according to the present embodiment. A printing apparatus 1000 is a line-type printing apparatus which has a conveyance unit 1 configured to convey a printing medium 2 and a line-type liquid ejection head 3 disposed to be substantially orthogonal to a printing medium conveyance direction and performs continuous printing with one pass while conveying a plurality of printing media 2 continuously or intermittently. The printing medium 2 is not limited to a cut sheet of paper and may be a continuous roll of paper. The liquid ejection head 3 is capable of full-color printing using CMYK (cyan, magenta, yellow, and black) liquid inks. The liquid ejection head 3 may be such that a single liquid ejection head corresponds to a single color or a plurality of colors. The liquid ejection head 3 is attached to the printing apparatus 1000 with replaceability. Through the liquid ejection head 3, a liquid supply unit forming supply channels through which ink is supplied to the liquid ejection head, an ink cartridge 1006 as a main tank, and a buffer tank 1003 are fluidically connected to one another, as will be described later (see FIG. 3). Also, an electric control unit is electrically connected to the liquid ejection head 3 to send power and ejection control signals to the liquid ejection head 3. Descriptions will be given later about liquid paths and electric signal paths in the liquid ejection head 3. The printing apparatus 1000 circulates ink through the liquid ejection head 3.

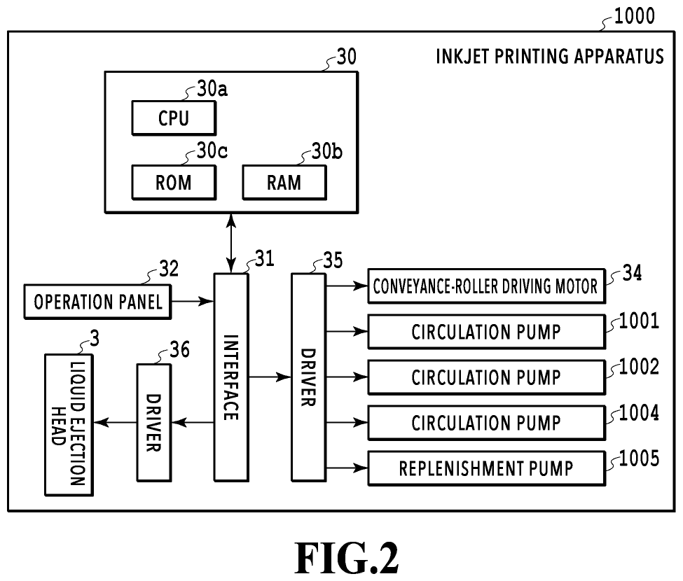

FIG. 2 is a block diagram showing the configuration of the printing apparatus 1000. The printing apparatus 1000 includes a control unit 30 having a CPU 30a such as a microprocessor and a RAM 30b which is used as a work area for the CPU 30a and as a place to, e.g., keep various kinds of data such as print data and a registration adjustment value. The control unit 30 also has a ROM 30c storing control programs for the CPU 30a and various kinds of data. The printing apparatus 1000 further includes an interface 31, an operation panel 32, and drivers 35, 36. The driver 35 drives and controls a conveyance-roller driving motor 34, circulation pumps 1001, 1002, 1004 disposed on ink supply flow channels, and a replenishment pump 1005, and the driver 36 drives the liquid ejection head 3.

Print data received by the printing apparatus 1000 is stored in the RAM 30b of the control unit 30. Based on the print data stored in the RAM 30b, the control unit 30 outputs ON and OFF signals for driving the motor 34 to the driver 35 and ejection signals and the like to the driver 36 to form an image on a printing medium. Also, the control unit 30 follows a control sequence to be described later to output a signal for driving the circulation pump 1002 to the driver 35 and controls the circulation pump 1002.

FIG. 3 is a schematic diagram showing a first circulation path as one mode of a circulation path employed in the printing apparatus according to the present embodiment. As shown in FIG. 3, the liquid ejection head 3 is fluidically connected to two first circulation pumps 1001 (high-pressure side), 1002 (low-pressure side), the buffer tank 1003, and the like. Note that for simpler illustration, FIG. 3 shows only channels through which one of CMYK inks flows, but in actuality, circulation channels for the respective four colors are provided in the liquid ejection head 3 and the main body of the printing apparatus.

The ink cartridge 1006 housing ink can be attached to the printing apparatus 1000, and the printing apparatus 1000 has the buffer tank 1003 as a sub tank connected to the ink cartridge 1006. The buffer tank 1003 has an atmosphere communication port (not shown) for allowing the inside and outside of the tank to communicate with each other and can discharge air bubbles in the ink to the outside. The buffer tank 1003 is connected to the replenishment pump 1005 as well. After ink is consumed by the liquid ejection head 3, the replenishment pump 1005 transfers ink from the ink cartridge 1006 to the buffer tank 1003 for the amount consumed. The ink is consumed by the liquid ejection head 3 by being ejected (discharged) from ejection ports of the liquid ejection head to perform, e.g., printing or suction recovery through ink ejection.

The two first circulation pumps 1001, 1002 serve to draw ink from liquid connection parts 111 of the liquid ejection head 3 and passes the ink to the buffer tank 1003. Displacement pumps capable of quantitative liquid delivery are preferable as the first circulation pumps 1001, 1002. Specific examples include a tube pump, a gear pump, a diaphragm pump, and a syringe pump, but the following mode is also possible where a typical constant flow valve or relief valve is disposed at the exist of each pump to achieve a constant flow rate. While the liquid ejection head 3 is driven, the first pump (high-pressure side) 1001 and the first circulation pump (low-pressure side) 1002 cause a constant amount of ink to flow inside a common supply flow channel 211 and a common collection flow channel 212. This flow amount is preferably set to be equal to or greater than a flow amount which allows print element substrates 10 in the liquid ejection head 3 to have temperature differences to a degree not affecting printed image quality. Setting too large a flow amount contributes to too large a difference in negative pressure between the print element substrates 10 due to pressure loss in the flow channels in a liquid ejection unit 300, resulting in uneven density of the image. For this reason, it is preferable to set the flow amount considering the temperature difference and negative pressure difference between the print element substrates 10.

A negative pressure control unit 230 is provided midway on a path connecting the second circulation pump 1004 and the liquid ejection unit 300 to each other. Thus, the negative pressure control unit 230 has a function to operate so as to maintain pressure at the downstream side (i.e., the liquid ejection unit 300 side) of the negative pressure control unit 230 at a preset constant pressure irrespective of fluctuations of the flow amount in the circulation system due to different print coverages. The negative pressure control unit 230 is formed by two pressure adjustment mechanisms, which may be any mechanisms as long as they can control pressure downstream of themselves with fluctuations within a certain range of a desired set pressure. An example mechanism to employ may be one similar to what is called a “pressure reducing regulator.” In a case where a pressure reducing regulator is used, it is preferable that, as shown in FIG. 3, the pressure at the upstream side of the negative pressure control unit 230 be increased by the second circulation pump 1004 via a liquid supply unit 220. This makes it possible for the water head pressure of the buffer tank 1003 to affect the liquid ejection head 3 less, and therefore the degree of freedom in the layout of the buffer tank 1003 in the printing apparatus 1000 can be improved. Any pump can be used as the second circulation pump 1004 as long as it has a certain lift pressure or greater within the ink circulation flow amount used while the liquid ejection head 3 is driven, and a turbo pump, a displacement pump, or the like can be used. Specifically, a diaphragm pump or the like can be employed. Also, for example, a head tank may be employed in place of the second circulation pump 1004, with the head tank disposed to have a certain head difference with respect to the negative pressure control unit 230.

As shown in FIG. 3, the negative pressure control unit 230 includes two pressure adjustment mechanisms for which control pressures different from each other are set. Of the two negative pressure adjustment mechanisms, the one for which a relatively high pressure is set (denoted as H in FIG. 3) is connected to the common supply flow channel 211 in the liquid ejection unit 300 through the liquid supply unit 220, and the one for which a relatively low pressure is set (denoted as L in FIG. 3) is connected to the common collection flow channel 212 through the liquid supply unit 220.

The liquid ejection unit 300 is provided with individual supply flow channels 213a and individual collection flow channels 214b communicating with the common supply flow channel 211, the common collection flow channel 212, and the respective print element substrates 10. Because the individual supply flow channels 213a and the individual collection flow channels 214b communicate with the common supply flow channel 211 and the common collection flow channel 212, a flow of ink is generated where part of ink passes from the common supply flow channel 211 to the common collection flow channel 212 through the flow channels inside the print element substrates 10 (as indicated with the arrows in FIG. 3). The reason for this is because the connection of the pressure adjustment mechanism H to the common supply flow channel 211 and the connection of the pressure adjustment mechanism L to the common collection flow channel 212 generate a difference in pressure between the two common flow channels.

In this way, flows are generated in the liquid ejection unit 300 such that while ink flows through the common supply flow channel 211 and the common collection flow channel 212, part of the ink passes through each of the print element substrates 10. For this reason, heat generated by the print element substrates 10 can be discharged to the outside of the print element substrates 10 along with the ink flowing through the common supply flow channel 211 and the common collection flow channel 212. Also, while the liquid ejection head 3 is printing, such a configuration can generate a flow of ink through ejection ports and pressure chambers not used for the printing as well; thus, thickening of ink at such portions can be reduced. Also, thickened ink and foreign matters in ink can be discharged to the common collection flow channel 212. Thus, the liquid ejection head 3 of the present embodiment is capable of high-speed, high image quality printing.

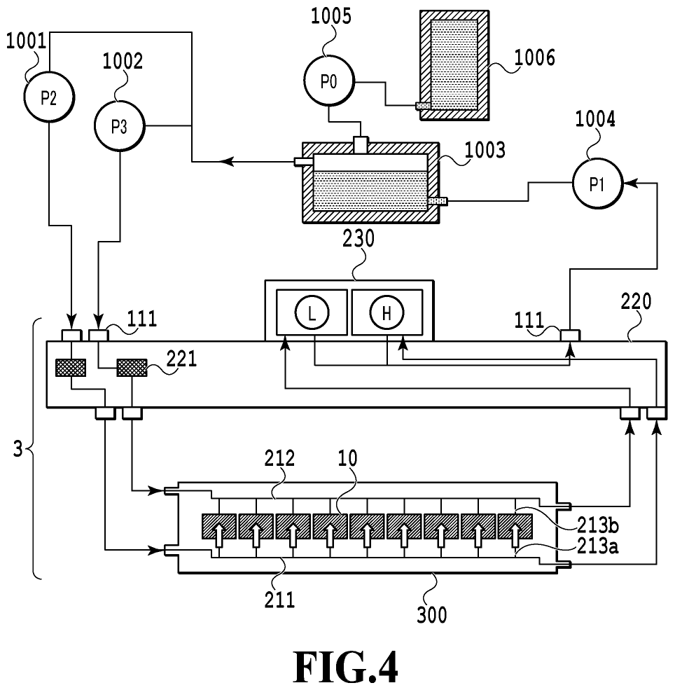

FIG. 4 is a schematic diagram showing, out of circulation paths to be employed in the printing apparatus 1000 according to the present embodiment, a second circulation path different from the first circulation path described above. Main differences from the first circulation path are as follows.

First, the two pressure adjustment mechanisms constituting the negative pressure control unit 230 both have a mechanism for controlling pressure upstream of the negative pressure control unit 230 with fluctuations within a certain range of a desired set pressure (a mechanism component acting similarly to what is called a “back-pressure regulator”). Also, the second circulation pump 1004 acts as a negative pressure source reducing the pressure downstream of the negative pressure control unit 230. Further, the first pump (high-pressure side) 1001 and the first circulation pump (low-pressure side) 1002 are disposed upstream of the liquid ejection head, and the negative pressure control unit 230 is disposed downstream of the liquid ejection head 3.

The negative pressure control unit 230 on the second circulation path operates so that fluctuations of pressure upstream thereof (i.e., the liquid ejection unit 300 side) may be within a certain range irrespective of fluctuations of the flow amount due to a change in print coverage while the liquid ejection head 3 is printing. For example, the pressure fluctuations are kept within a certain range of a preset pressure. As shown in FIG. 4, it is preferable that the downstream side of the negative pressure control unit 230 be increased in pressure by the second circulation pump 1004 through the liquid supply unit 220. This enables the water head pressure of the buffer tank 1003 to affect the liquid ejection head 3 less and thus improves the degree of freedom in the layout of the buffer tank 1003 in the printing apparatus 1000. Note that, for example, a head tank may be employed in place of the second circulation pump 1004, with the head tank disposed to have a certain head difference with respect to the negative pressure control unit 230.

As with the first circulation path, the negative pressure control unit 230 shown in FIG. 4 includes two pressure adjustment mechanisms for which control pressures different from each other are set. Of the two negative pressure adjustment mechanisms, the one for which a relatively high pressure is set (denoted as H in FIG. 4) is connected to the common supply flow channel 211 in the liquid ejection unit 300 through the liquid supply unit 220, and the one for which a relatively low pressure is set (denoted as L in FIG. 4) is connected to the common collection flow channel 212 through the liquid supply unit 220.

These two negative pressure adjustment mechanisms make the pressure in the common supply flow channel 211 relatively higher than the pressure in the common collection flow channel 212. This configuration generates a flow of ink flowing from the common supply flow channel 211 to the common collection flow channel 212 through the individual supply flow channels 213 and flow channels inside the print element substrates 10 (as indicated with the arrows in FIG. 4). In this way, the second circulation path achieves an ink flowing state in the liquid ejection unit 300 similar to that achieved by the first circulation path and also has two advantages not achieved with the first circulation path.

A first advantages is that there is less concern that contaminants or foreign matters generated from the negative pressure control unit 230 will flow into the liquid ejection head 3 because the negative pressure control unit 230 on the second circulation path is disposed downstream of the liquid ejection head 3. A second advantage is that the maximum value of the necessary flow amount of ink supplied from the buffer tank 1003 to the liquid ejection head 3 is smaller for the second circulation path than for the first circulation path. The reason for this is as follows. With A being the total of a flow amount in the common supply flow channel 211 and a flow amount in the common collection flow channel 212 during circulation in print standby, the value of A is defined as a minimum flow amount necessary to keep a temperature difference in the liquid ejection unit 300 within a desired range in a case where temperature adjustment of the liquid ejection head 3 is performed during print standby. Also, an ejection flow amount used in ejecting ink from all the ejection ports of the liquid ejection unit 300 is defined as F. Then, for the first circulation path (see FIG. 3), the set flow amount for the first pump (high-pressure side) 1001 and the first circulation pump (low-pressure side) 1002 is A; thus, the maximum value of the amount of liquid needed to be supplied to the liquid ejection head 3 for full ejection is A+F.

Meanwhile, for the second circulation path (see FIG. 4), the amount of liquid that needs to be supplied to the liquid ejection head 3 during print standby is the flow amount A, and the amount of liquid that needs to be supplied in full ejection is the flow amount F. Then, for the second circulation path, the total value of the set flow amount for the first pump (high-pressure side) 1001 and the set flow amount for the first circulation pump (low-pressure side) 1002, i.e., the maximum value of the necessary supply flow amount is the larger one of A and F. Thus, as long as the liquid ejection unit 300 of the same configuration is used, the maximum value of the necessary supply amount for the second circulation path (A or F) is always smaller than the maximum value of the necessary supply amount for the first circulation path (A+F). Thus, the degree of freedom as to which circulation pump to employ is higher with the second circulation path. Thus, for example, an inexpensive circulation pump with a simple configuration can be used, or load on a cooler (not shown) installed on a path on the main body side can be reduced, which advantageously reduces cost for the main body of the printing apparatus. This advantage is more notable for a line head where the value of A or F is relatively large and is more beneficial for a line head which is longer in the longitudinal direction than other line heads.

However, the first circulation path has some advantages over the second circulation path. Specifically, for the second circulation path, the amount of ink flowing through the liquid ejection unit 300 is at its maximum during print standby, and thus, the smaller the print coverage, the higher the negative pressure applied to each ejection port. Thus, especially in a case where the flow channel widths of the common supply flow channel 211 and the common collection flow channel 212 (as measured in a direction orthogonal to the ink flowing direction) are reduced to shorten the head width (as measured in a direction along the shorter side of the liquid ejection head), high negative pressure is applied to the ejection ports for a low-coverage image where unevenness is easily visible. Such application of high negative pressure may result in increased satellite droplets. Meanwhile, the first circulation path has the following advantage. Specifically, because high negative pressure is applied to the ejection ports at the time of formation of an image with high print coverage, satellite droplets, if generated, are not easily visible, and therefore the printed image is affected less. Between the two circulation paths, a favorable one can be selected considering the specifications of the liquid ejection head and the main body of the printing apparatus (the ejection flow amount F, the minimum circulation flow amount A, and resistance in the flow channels in the head).

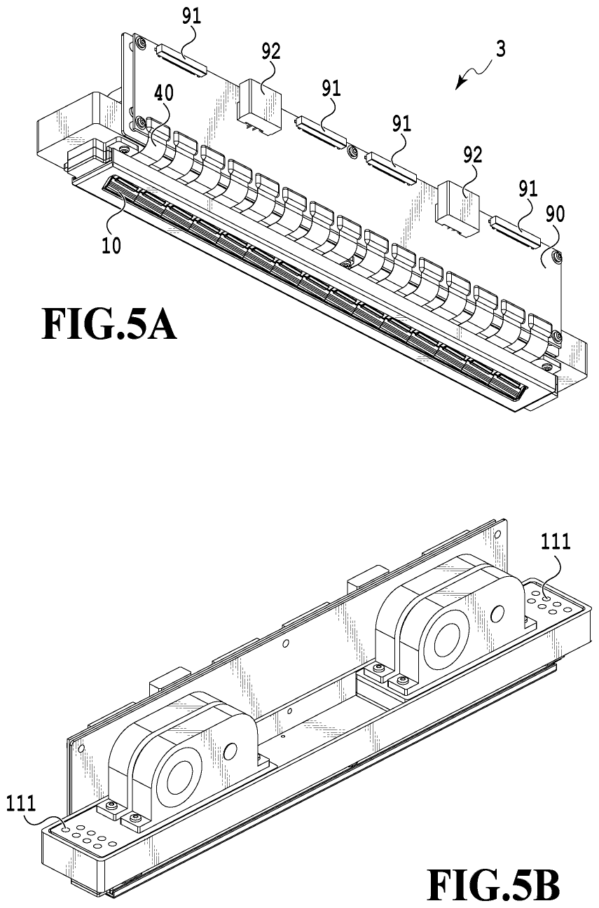

FIGS. 5A and 5B are perspective views of the liquid ejection head 3. In FIGS. 5A to 13 and the following description, as an example, a single liquid ejection head ejects four colors of ink. As shown in FIG. 5A, the liquid ejection head 3 has signal input terminals 91 and power supply terminals 92 which are electrically connected to the print element substrates 10 via flexible wiring substrates 40 and an electric wiring substrate 90. The signal input terminals 91 and the power supply terminals 92 are electrically connected to the control unit of the printing apparatus 1000, so that ejection drive signals are supplied to the print element substrates 10 through the signal input terminals 91 and power needed for ejection is supplied to the print element substrates 10 through the power supply terminals 92.

Wiring consolidation by electric circuitry inside the electric wiring substrate 90 enables the signal input terminals 91 and the power supply terminals 92 to be fewer in number than the print element substrates 10. This means that fewer electric connection components need to be attached at the time of attachment of the liquid ejection head 3 to the printing apparatus 1000 and to be removed at the time of replacement of the liquid ejection head 3. As shown in FIG. 5B, the liquid connection parts 111 provided at both end portions of the liquid ejection head 3 are connected to a liquid supply system of the printing apparatus 1000. Inks in four CMYK colors are thereby supplied from the supply system of the printing apparatus 1000 to the liquid ejection head 3, and ink that has passed through the liquid ejection head 3 is collected into the supply system of the printing apparatus 1000. In this way, the ink in each color can be circulated through paths in the printing apparatus 1000 and paths in the liquid ejection head 3.

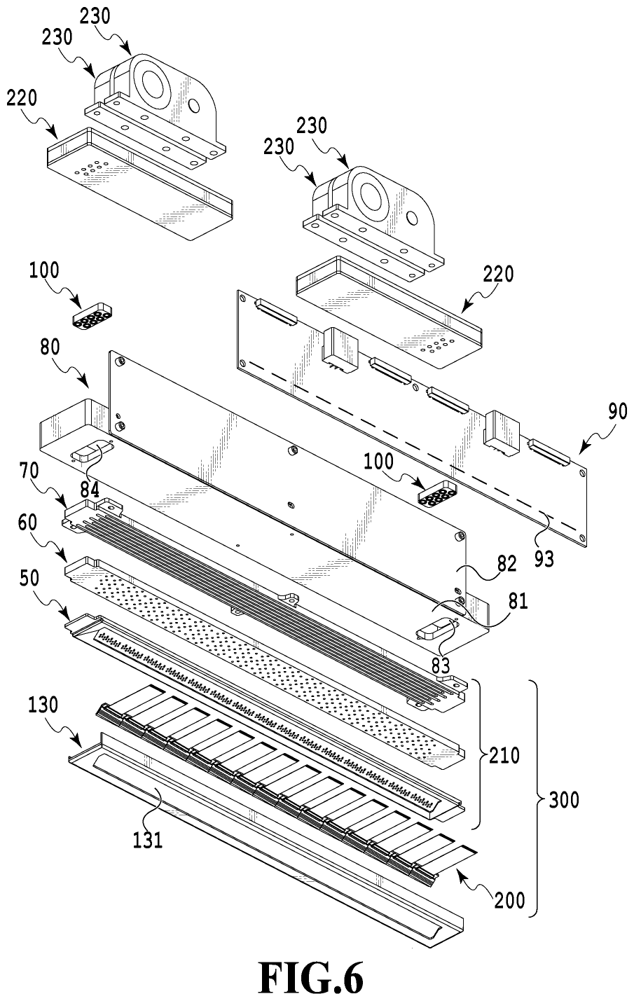

FIG. 6 is an exploded perspective view of components and units constituting the liquid ejection head 3. The liquid ejection unit 300, the liquid supply units 220, and the electric wiring substrate 90 are attached to a casing 80. Each of the liquid supply units 220 is provided with the liquid connection parts 111 (see FIGS. 3 and 4), and filters 221 (see FIG. 4) for corresponding inks are provided in the liquid supply unit 220, communicating with the respective openings of the liquid connection parts 111 to remove foreign matters in the ink to be supplied. Each of the two liquid supply units 220 is provided with the filters 221 for two colors. Ink that has passed through the filters 221 is supplied to the negative pressure control units 230 disposed above the liquid supply unit 220 in correspondence to the respective colors.

The negative pressure control units 230 are each a unit formed of pressure regulating valves for a corresponding color. Using the action of valves, spring members, and the like provided inside, the negative pressure control units 230 drastically attenuate a change in pressure loss inside the supply system of the printing apparatus 1000 (a supply system upstream of the liquid ejection head 3) caused by fluctuations of the flow amount of ink. Thus, the negative pressure control unit 230 can stabilize a change in negative pressure downstream of the pressure control unit (the liquid ejection unit 300 side) within a certain range. As depicted in FIG. 3, the negative pressure control unit 230 for each color has two pressure regulation valves for the color. Different control pressures are set for these pressure regulation valves, with the high pressure side communicating with the common supply flow channel 211 and the low pressure side communicating with the common collection flow channel 212 in the liquid ejection unit 300 through the liquid supply unit 220.

The casing 80 is formed by a liquid-ejection-unit support part 81 and an electric-wiring-substrate support part 82, and the casing 80 supports the liquid ejection unit 300 and the electric wiring substrate 90 and also adds rigidity to the liquid ejection head 3. The electric-wiring-substrate support part 82 supports the electric wiring substrate 90 and is screwed and fixed to the liquid-ejection-unit support part 81. The liquid-ejection-unit support part 81 serves to correct warpage and deformation of the liquid ejection unit 300 and ensure accuracy in the relative positions of the plurality of print element substrates 10, and thereby reduces streaks and unevenness on a printed product. Thus, the liquid-ejection-unit support part 81 preferably has adequate rigidity, and favorable materials therefor include metal materials such as SUS and aluminum and ceramics such as alumina. The liquid-ejection-unit support part 81 is provided with openings 83, 84 to insert joint rubbers 100. Ink supplied from the liquid supply unit 220 is led to a third flow channel member 70 constituting the liquid ejection unit 300, through the joint rubber.

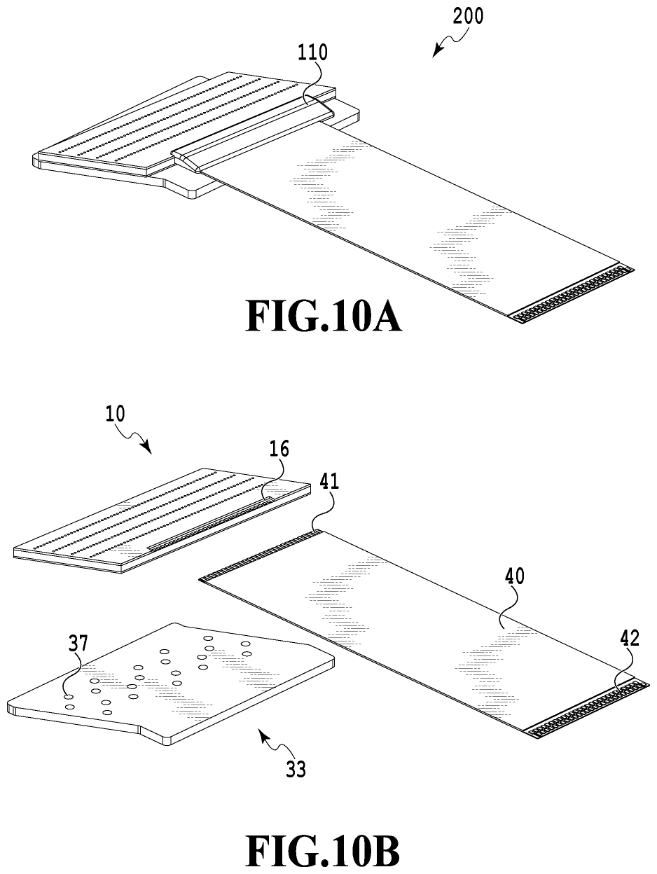

The liquid ejection unit 300 has a plurality of ejection modules 200 and a flow channel member 210, and a cover member 130 is attached to the printing-medium-side surface of the liquid ejection unit 300. As shown in FIG. 6, the cover member 130 is a member with a frame-shaped surface and has an elongated opening 131 exposing the print element substrates 10 and sealers 110 (see FIGS. 10A and 10B) included in the respective ejection modules 200. The frame part around the opening 131 functions as an abutment surface against which a cap member which caps the liquid ejection head 3 abuts during print standby. Thus, it is preferable that an adhesive, a sealer, a filler, or the like is applied to the frame part surrounding the opening 131 to fill the unevenness and gaps on the ejection-port surface of the liquid ejection unit 300, so that a closed space will be formed in a capped state.

Next, the configuration of the flow channel member 210 included in the liquid ejection unit 300 is described. As shown in FIG. 6, the flow channel member 210 is a stack of a first flow channel member 50, a second flow channel member 60, and the third flow channel member 70. The flow channel member 210 distributes ink supplied from the liquid supply units 220 to the ejection modules 200 and returns ink recirculated from the ejection modules 200 to the liquid supply unit 220. The flow channel member 210 is screwed and fixed to the liquid-ejection-unit support part 81 and is thereby reduced in warpage and deformation.

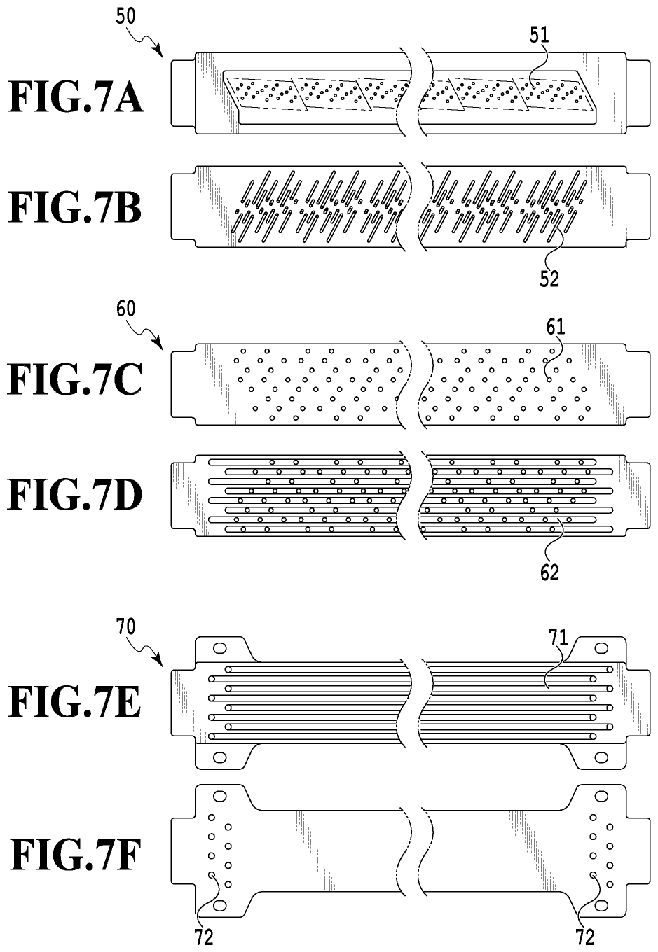

FIGS. 7A and 7F are diagrams showing the front and back surfaces of each of the first to third flow channel members. FIG. 7A shows a surface of the first flow channel member 50 on the side where the ejection modules 200 are installed, and FIG. 7F shows a surface of the third flow channel member 70 which abuts against the liquid-ejection-unit support part 81. The first flow channel member 50 and the second flow channel member 60 are joined together with the surface shown in FIG. 7B and the surface shown in FIG. 7C, which are abutment surfaces of the respective flow channel members, facing each other. The second flow channel member and the third flow channel member are joined together with the surface shown in FIG. 7D and the surface shown in FIG. 7E, which are abutment surfaces of the respective flow channel members, facing each other. With the second flow channel member 60 and the third flow channel member 70 joined together, eight common flow channels extending in the direction of the longer side of the flow channel members are formed by common flow channel grooves 62 and common flow channel grooves 71 formed in the respective flow channel members. As a result, as shown in FIG. 7A to 7F, for each of the colors, a set of the common supply flow channel 211 and the common collection flow channel 212 is formed in the flow channel member 210. Communication ports 72 in the third flow channel member 70 communicate with the respective holes in the joint rubbers 100 and fluidically communicate with the liquid supply units 220. A plurality of communication ports 61 are formed in the bottom surface of each of the common flow channel grooves 62 in the second flow channel member 60, communicating with one end portions of individual flow channel grooves 52 in the first flow channel member 50. Communication ports 51 are formed at the other end portions of the individual flow channel grooves 52 in the first flow channel member 50, and the individual flow channel grooves 52 fluidically communicate with the plurality of ejection modules 200 through the communication ports 51. The individual flow channel grooves 52 allow the flow channels to be consolidated to the center side of the flow channel member.

The first to third flow channel members preferably have corrosion resistance to liquid and are made of a material with a low coefficient of linear expansion. Examples of favorably usable materials include a composite material (a resin material) formed of a basic material and an additive, the basic material being alumina, a liquid crystal polymer (LCP), polyphenylene sulfide (PPS), or polysulfone (PSF), the additive being an inorganic filler such as fine silica particles or fibers. The flow channel member 210 can be formed by stacking and bonding the three flow channel members to each other, or by welding them in a case where a composite resin material is selected as their materials.

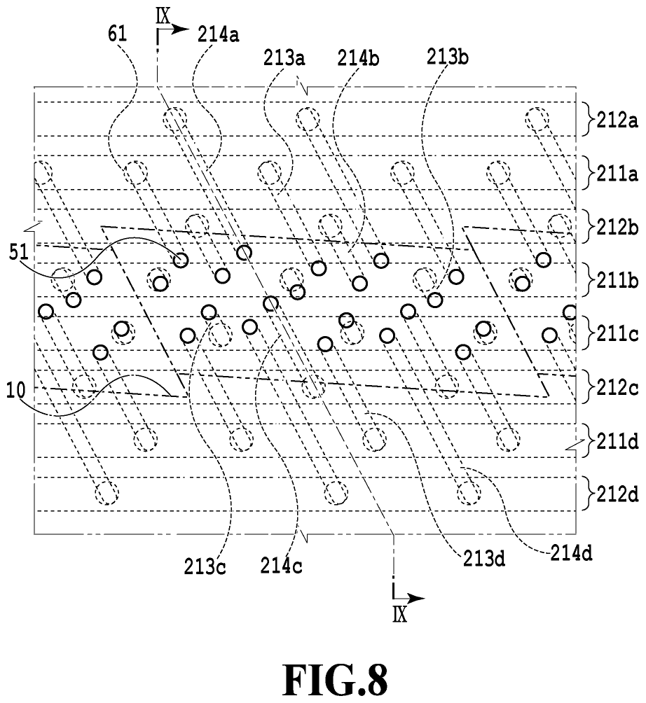

FIG. 8 is a see-through, partly enlarged view of the flow channels in the flow channel member 210 formed by joining the first to third flow channel members, as seen from the surface of the first flow channel member 50 where the ejection modules 200 are installed. The connection relations between the flow channels in the flow channel member 210 are described below. The flow channel member 210 is provided with the common supply flow channels 211 (211a, 211b, 211c, 211d) and the common collection flow channels 212 (212a, 212b, 212c, 212d) for the respective colors, extending in the direction of the longer side of the liquid ejection head 3. The plurality of individual supply flow channels (213a, 213b, 213c, 213d) formed by the individual flow channel grooves 52 are connected to the common supply flow channels 211 for the corresponding colors through the communication ports 61. Also, the plurality of individual collection flow channels (214a, 214b, 214c, 214d) formed by the individual flow channel grooves 52 are connected to the common collection flow channels 212 for the corresponding colors through the communication ports 61. Such a flow channel configuration allows ink to be consolidated from the common supply flow channels 211 to the print element substrates 10 located at the center portion of the flow channel member 210 through the individual supply flow channels 213. Also, ink can be collected from the print element substrates 10 to the common collection flow channels 212 through the individual collection flow channels 214.

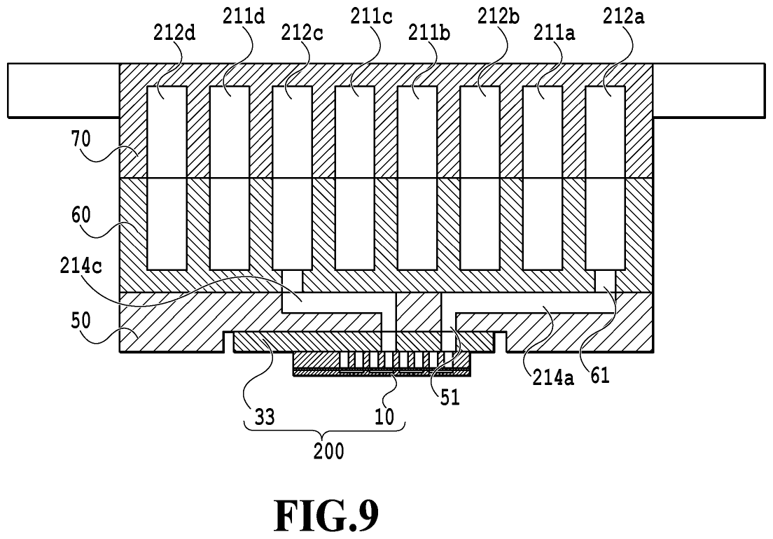

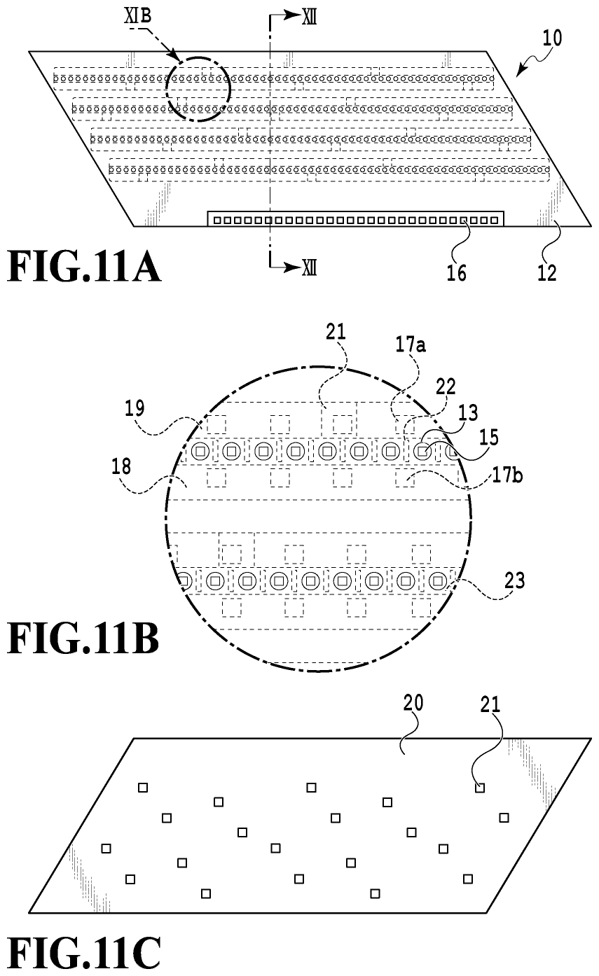

FIG. 9 is a diagram showing a section taken along the line IX-IX in FIG. 8. As shown in FIG. 9, the individual collection flow channels (214a, 214c) communicate with the ejection module 200 via the communication ports 51. Although FIG. 9 shows only the individual collection flow channels (214a, 214c), the individual supply flow channels 213 communicate with the ejection module 200 on a different section, as shown in FIG. 8. To supply ink from the first flow channel member 50 to print elements 15 (see FIG. 11B) provided at the print element substrate 10, flow channels are formed in a support member 33 and the print element substrate 10 which are included in each ejection module 200. Also, to collect (recirculate) part or all of the ink supplied to the print elements 15 to the first flow channel member 50, flow channels are formed in the support member 33 and the print element substrate 10. The common supply flow channel 211 for each color is connected to (the high pressure side of) the negative pressure control unit 230 for the corresponding color through the liquid supply unit 220, and the common collection flow channel 212 is connected to (the low pressure side of) the negative pressure control unit 230 through the liquid supply unit 220. This negative pressure control unit 230 generates a differential pressure (difference in pressure) between the common supply flow channel 211 and the common collection flow channel 212. Thus, in the liquid ejection head where the flow channels are connected as shown in FIGS. 8 and 9, a flow of ink is generated as follows for each color: the common supply flow channel 211 to the individual supply flow channels 213a, to the print element substrates 10, to the individual collection flow channels 214b, and to the common collection flow channel 212.

FIG. 10A is a perspective view showing a single ejection module 200, and FIG. 10B is an exploded view of the ejection module 200. The ejection module 200 is manufactured as follows. First, the print element substrate 10 and the flexible wiring substrate 40 are bonded onto the support member 33 provided with liquid communication ports 37 in advance. After that, a terminal 16 on the print element substrate 10 and a terminal 41 on the flexible wiring substrate 40 are electrically connected by wire bonding, and the wire-bonded part (an electric connection part) is covered and sealed by the sealer 110. A terminal 42 on the flexible wiring substrate 40 located opposite from the print element substrate 10 is electrically connected to a connection terminal 93 of the electric wiring substrate 90 (see FIG. 6). The support member 33 is a support that supports the print element substrate 10 and is also a flow channel member allowing the print element substrate 10 and the flow channel member 210 to fluidically communicate with each other. Thus, it is preferable that the support member 33 have high flatness and can be joined to the print element substrate with sufficiently high reliability. Preferable materials include, for example, alumina and a resin material.

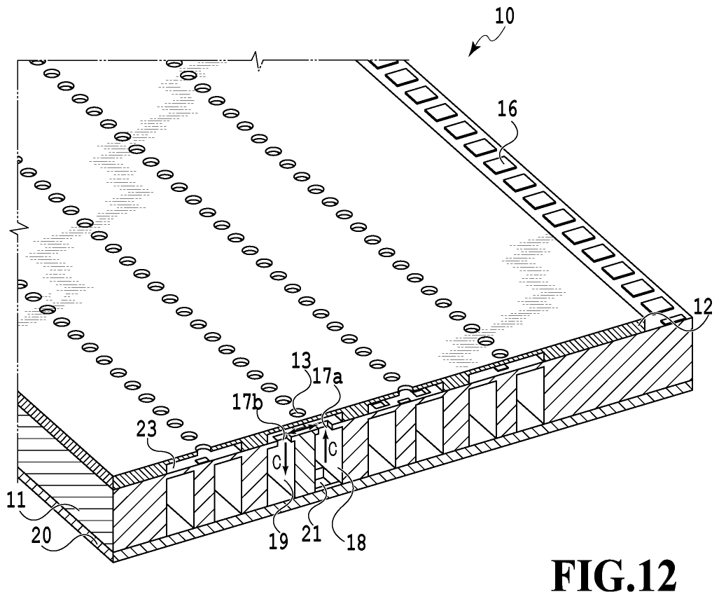

FIG. 11A is a plan view of the surface of the print element substrate 10 on the side where ejection ports 13 are formed, FIG. 11B is a diagram showing a close-up of a part denoted by XIB in FIG. 11A, and FIG. 11C is a plan view of the back surface of FIG. 11A. FIG. 12 is a perspective view showing a section of the print element substrate 10 and a lid member 20, taken along the sectional line XII-XII shown in FIG. 11A. The configuration of the print element substrate 10 is described below.

As shown in FIG. 11A, four ejection port arrays corresponding to the respective colors are formed in an ejection-port formation member 12 of the print element substrate 10. Note that a direction in which an ejection port array of a plurality of ejection ports 13 extends is hereinafter referred to as an “ejection port array direction.”

As shown in FIG. 11B, as heat generating elements for forming bubbles in ink using heat energy, the print elements 15 are disposed at positions corresponding to the ejection ports 13. Partitioning walls 22 define pressure chambers 23 each having the print element 15 inside. The print elements 15 are electrically connected to the terminal 16 in FIG. 11A by electric wiring (not shown) provided at the print element substrate 10. The print element 15 generates heat and boils ink based on a pulse signal inputted from the control circuit in the printing apparatus 1000 through the electric wiring substrate 90 (FIG. 5A) and the flexible wiring substrate 40 (see FIG. 10B). This boiling produces a bubble, the force of which causes ink to be ejected from the ejection port 13. As shown in FIG. 12B, along each ejection port array, a liquid supply channel 18 extends on one side, and a liquid collection channel 19 extends on the other side. The liquid supply channel 18 and the liquid collection channel 19 are flow channels provided in the print element substrate 10 and extending in the ejection port array direction, and they communicate with the ejection ports 13 through supply ports 17a and collection ports 17b, respectively.

As shown in FIGS. 11B and 12, the sheet-shaped lid member 20 is stacked onto a surface of the print element substrate 10 opposite from its surface where the ejection ports 13 are formed. The lid member 20 is provided with a plurality of openings 21 communicating with the liquid supply channels 18 and the liquid collection channels 19, as will be described later. The lid member 20 has three openings 21 for every liquid supply channel 18 and two openings 21 for every liquid collection channel 19. As shown in FIG. 11C, the openings 21 in the lid member 20 communicate with the plurality of communication ports 51 shown in FIG. 8 and the like. As shown in FIG. 12, the lid member 20 functions as a lid forming part of the walls of the liquid supply channels 18 and the liquid collection channels 19 formed in a substrate 11 of the print element substrate 10. The lid member 20 is preferably one with sufficient corrosion resistance to ink, and also, high precision is required for the opening shapes and opening positions of the openings 21 from the perspective of prevention of color mixing. For this reason, it is preferable to use a photosensitive resin material or a silicon plate as a material for the lid member 20 and provide the openings 21 using a photolithographic process. In this way, the lid member uses the openings 21 to convert the flow channel pitch and is, considering pressure loss, desirably thin in thickness and desirably formed by a film-shaped member.

Next, how ink flows in the print element substrate 10 is described. As shown in FIG. 12, the print element substrate 10 is a stack of the substrate 11 formed of Si and the ejection-port formation member 12 formed of a photosensitive resin, and has the lid member 20 joined to the back surface of the substrate 11. The print elements 15 are formed at one surface side of the substrate 11 (see FIG. 11B), and grooves forming the liquid supply channels 18 and the liquid collection channels 19 are formed at the back surface side of the substrate 11, extending along the ejection port arrays. The liquid supply channels 18 and the liquid collection channels 19 formed by the substrate 11 and the lid member 20 are connected to the common supply flow channels 211 and the common collection flow channels 212 in the flow channel member 210, respectively, and there is differential pressure between the liquid supply channels 18 and the liquid collection channels 19.

While the liquid ejection head 3 is performing printing by ejecting ink from a plurality of ejection ports 13, at ejection ports not used in the ejection operation, the differential pressure causes the ink in the liquid supply channels 18 provided in the substrate 11 to flow as indicated by the arrow C in FIG. 12. Specifically, ink flows to the liquid collection channel 19 via the supply ports 17a, the pressure chambers 23, and the collection ports 17b. At the ejection ports 13 and the pressure chambers 23 not used in the printing, this flow enables thickened ink generated by evaporation from the ejection ports 13, bubbles, foreign matters, and the like to be collected into the liquid collection channels 19. It is also possible to reduce thickening of ink at the ejection ports 13 and the pressure chambers 23. Ink collected into the liquid collection channel 19 is collected through the openings 21 of the lid member 20 and the liquid communication ports 37 of the support member 33 (see FIG. 10B) and then through the communication ports 51, the individual collection flow channels 214, and the common collection flow channel 212 in the flow channel member 210, in this order. This ink is finally collected to the supply path in the printing apparatus 1000.

In other words, ink supplied from the main body of the printing apparatus to the liquid ejection head 3 flows as follows to be supplied and collected. First, ink flows from the liquid connection parts 111 of the liquid supply unit 220 into the liquid ejection head 3. The ink is then supplied in the order of the joint rubbers 100, the communication ports 72 and the common flow channel grooves 71 provided in the third flow channel members, the common flow channel grooves 62 and the communication ports 61 provided in the second flow channel member, and the individual flow channel grooves 52 and the communication ports 51 provided in the first flow channel member. After that, the ink is supplied to the pressure chambers 23 through the liquid communication ports 37 provided in the support member 33, the openings 21 provided in the lid member, and the liquid supply channels 18 and the supply ports 17a provided in the substrate 11, in this order. Of the ink supplied to the pressure chambers 23, ink not ejected from the ejection ports 13 flows through the collection ports 17b and the liquid collection channels 19 provided in the substrate 11, the openings 21 provided in the lid member, and the liquid communication ports 37 provided in the support member 33, in this order. After that, the ink flows through the communication ports 51 and the individual flow channel grooves 52 provided in the first flow channel member, the communication ports 61 and the common flow channel grooves 62 provided int the second flow channel member, the common flow channel grooves 71 and the communication ports 72 provided in the third flow channel member 70, and the joint rubbers 100, in this order. Further, ink flows to the outside of the liquid ejection head 3 through the liquid connection parts 111 provided in the liquid supply unit. In a case where the first circulation path shown in FIG. 3 is employed, ink flowing in through the liquid connection parts 111 is supplied to the joint rubbers 100 after passing through the negative pressure control units 230. In a case where the second circulation path shown in FIG. 4 is employed, ink collected from the pressure chambers 23 passes through the joint rubbers 100 and flows outside of the liquid ejection head from the liquid connection parts 111 via the negative pressure control units 230.

Also, as shown in FIGS. 3 and 4, not all the ink flowing in from one ends of the common supply flow channels 211 in the liquid ejection unit 300 is supplied to the pressure chamber 23 through the individual supply flow channels 213a. Some part of the ink flows from the other ends of the common supply flow channels 211 to the liquid supply unit 220 without flowing into the individual supply flow channels 213a. By thus having a path for ink to flow without passing through the print element substrates 10, even the print element substrate 10 having fine flow channels with high flow resistance can reduce regurgitation of circulation flow of ink. In this way, thickening of ink can be reduced near the pressure chambers and the ejection ports in the liquid ejection head 3, which helps prevent ink from being ejected in a direction offset from the normal direction or from failing to be ejected. As a result, images with high quality can be printed.

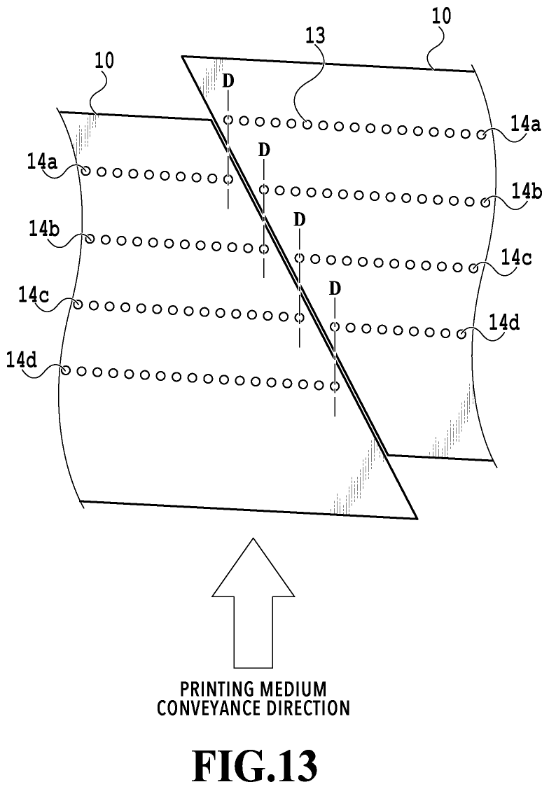

FIG. 13 is a plan view showing a close-up of a part where the print element substrates 10 of two adjacent ejection modules are adjacent to each other. As shown in FIG. 11A and the like, the print element substrates 10 substantially shaped like parallelograms are used. As shown in FIG. 13, each of the ejection port arrays (14a to 14d) of the ejection ports 13 in each print element substrate 10 is disposed in such a manner as to be slanted by a certain angle relative to the print medium conveyance direction. Thus, the ejection port arrays at the part where the print element substrates 10 are adjacent to each other are such that at least one ejection port in one of the print element substrates 10 overlaps with at least one in the other one of the print element substrates 10 as seen in the print medium conveyance direction. In FIG. 13, two ejection ports on line D overlap with each other. With this arrangement, even in a case where the positions of the print element substrates 10 are somewhat off from their predetermined positions, driving control of the overlapping ejection ports can make black streaks or voids on a printed image less noticeable. Even in a case where the plurality of print element substrates 10 are arranged not in a staggered manner but linearly (in-line), a configuration like the one shown in FIG. 13 can still be achieved. Thus, a measure can be taken against black streaks and voids at the joint area of the print element substrates 10 while mitigating an increase in the length of the liquid ejection head 3 measured in the print medium conveyance direction. Note that although the main surface of the print element substrate 10 is a parallelogram here, the present disclosure is not limited to this. The configuration can favorably applied even in a case of using print element substrates with, for example, rectangular, trapezoidal, or other shapes.

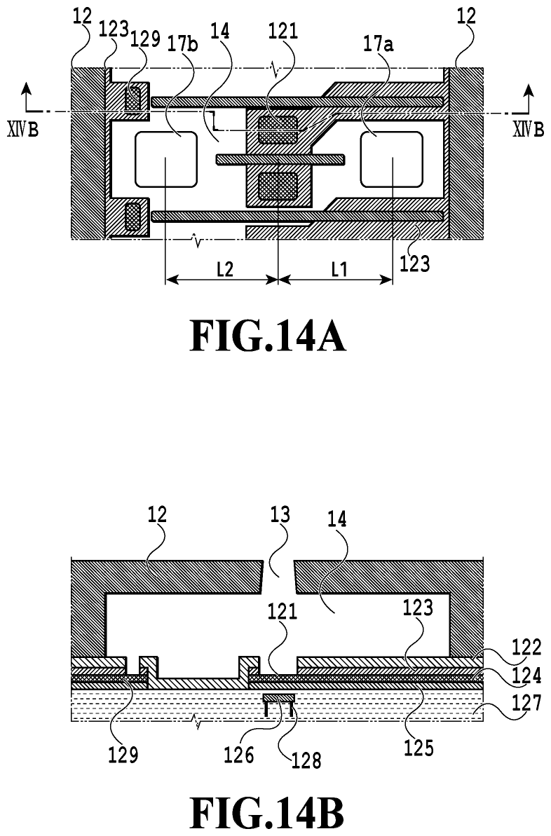

FIG. 14A is a plan view schematically showing a close-up of an area near a heat action portion of the print element substrate 10, and FIG. 14B is a sectional view taken along the dot-dash line XIVB-XIVB in FIG. 14A. The following describes the structure of the heat action portion of the print element substrate according to the present embodiment.

In the liquid ejection head 3, a plurality of layers are stacked on a base formed of silicon (not shown), thereby forming a print substrate. In the present embodiment, a heat storage layer (not shown) formed by a thermal oxidized film, a SiO film, a SiN film, or the like is disposed on the base. Also, a heat generating resistor 126 is disposed above the heat storage layer, and an electrode wiring layer (not shown) as wiring formed of a metal material such as Al, Al—Si, or Al—Cu is connected to the heat generating resistor 126 through tungsten plugs 128 (the electrode wiring layer is formed as a layer under an insulating protection layer 127 in FIG. 14B). The heat generating resistor 126 generates heat upon energization through the electrode wiring layer (not shown). By generating heat, the heat generating resistor 126 causes film boiling in the ink in a bubble formation chamber 14, thereby ejecting ink from the ejection port 13 to print on a print medium.

As shown in FIG. 14B, the heat generating resistor 126 is covered by the insulating protection layer 127. The insulating protection layer 127 is an insulating layer provided over the heat generating resistor 126 as well to cover the heat generating resistor 126. The insulating protection layer 127 is formed of a SiO film, a SiN film, or the like.

Three protection layers are disposed on the insulating protection layer 127 to keep the insulating protection layer 127 from contacting liquid. The three protection layers include a lower protection layer 125, an upper protection layer 124, and an adhesion protection layer 123 and protect the surface of the heat generating resistor 126 from chemical and physical impacts caused by heat generated by the heat generating resistor 126.

In the present embodiment, the lower protection layer 125 is formed of tantalum (Ta); the upper protection layer 124, iridium (Ir); and the adhesion protection layer 123, tantalum (Ta). Also, the protection layers formed of these materials are electrically conductive. An adhesion protection layer 122 is disposed on the adhesion protection layer 123 to improve resistance to liquid and adhesiveness with the ejection-port formation member 12. The adhesion protection layer 122 is formed of SiC. The adhesion protection layer 122 is not disposed at a location corresponding to the heat generating resistor 126, so the upper protection layer 124 is exposed in the pressure chamber 23, acting as a protection portion for the heat generating resistor 126. This region serves as a heat action portion during an ejection operation. The upper protection layer 124 is formed of a material which contains metal dissolved by an electrochemical reaction and which, under heat, does not form an oxide film that hinders the dissolution.

The upper protection layer 124 in the heat action portion is in contact with liquid, and in ejection of liquid, the liquid is instantaneously increased in temperature and generates a bubble, which then breaks, causing cavitation. For this reason, the upper protection layer 124 formed of an iridium material with high corrosion resistance and high reliability is disposed at a location to be in contact with liquid in the present embodiment.

In the present embodiment, the pressure chamber 23 employs an ink circulation configuration where liquid is supplied from the supply port 17a and is collected to the collection port 17b. Thus, during printing, liquid flows in a direction from the upstream supply port 17a to the downstream collection ports 17b above the heat generating resistor 126.

In the present embodiment, in addition to a conventional kogation removal process, a kogation reduction process is performed to help prevent kogation from depositing on the upper protection layer 124 above the heat generating resistor 126. This kogation reduction process can be performed during liquid ejection.

Kogation occurs as a result of particles in ink being heated by the heat generating resistor 126 during ejection and is, after repeated ejection, deposited on the surface of the upper protection layer 124 which forms a heat action portion during ejection. Particles in ink which are a cause of kogation are charged, and the polarity with which the particles are charged differs depending on the type of the particles. There is a typical tendency where particles of a colorant such as a pigment in ink are charged negatively, and metallic particles and the like are charged positively. In other words, the polarity of the charge on the particles which can cause kogation differs depending on the type of particles contained in ink.

The following gives a detailed description of the kogation reduction process of the present embodiment, taking an example where the printing apparatus 1000 ejects ink containing a negatively-charged pigment. A part of the upper protection layer 124 which is immediately above the heat generating resistor 126 is used as a negative electrode 121, and a region of the upper protection layer 124 which is at a position separated from the electrode 121 is used as an electrode 129. The electrode 121 and the electrode 129 are configured to be electrically conductive through a liquid. Thus, particles of a pigment or the like negatively charged is repelled by the negative electrode 121, and the abundance of such particles is lowered near the electrode 121. This as a result can reduce kogation deposited on the electrode 121 during printing. The abundance of a colorant, an additive, or the like that can cause kogation can thus be lowered near the surface of the upper protection layer 124 above the heat generating resistor 126 to reduce kogation.

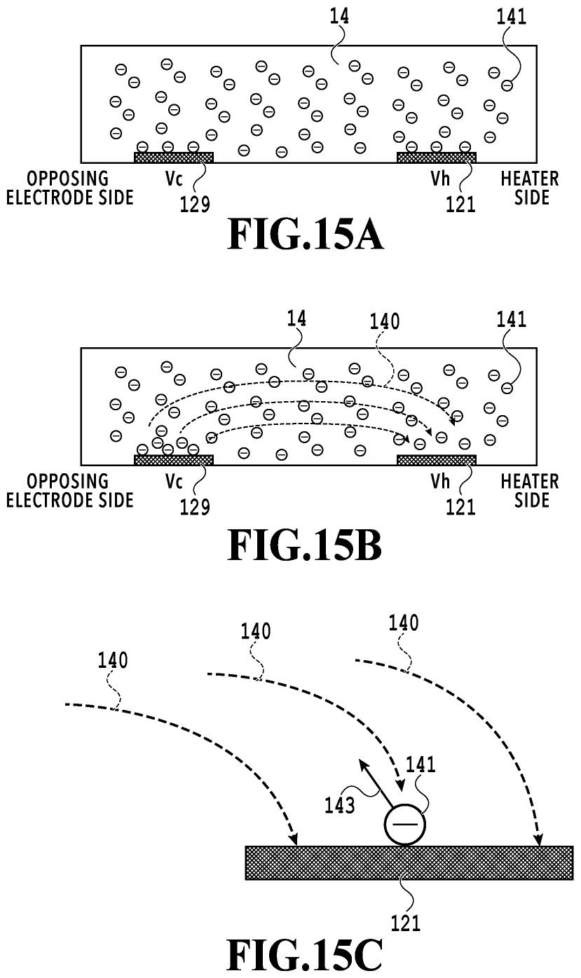

FIGS. 15A to 15C are schematic diagrams showing the kogation reduction process performed in a case where negatively charged particles in the bubble formation chamber 14 are a dominant factor for kogation. Using FIGS. 15A to 15C, the following describes a mechanism of potential control used in the present embodiment. As shown in FIG. 15A, the electrode 121 and the opposing electrode 129 are disposed in the bubble formation chamber 14, and the bubble formation chamber 14 is filled with liquid (ink). The liquid contains negatively charged particles 141 of a pigment or the like, and the particles 141 are dispersed in the liquid substantially evenly.

FIG. 15B shows a state where voltage is being applied to make the potential of the electrode 121 relatively lower than the potential of the opposing electrode 129. The difference in potential between the electrode 121 and the opposing electrode 129 is preferably in the range of 0.5 V to 2.5 V. In this state, an electric field 140 is formed between the electrode 121 and the opposing electrode 129 via the liquid, but no current is flowing. Because the electrode 121 is charged negatively relative to the opposing electrode 129, the negatively charged particles 141 are repelled by the electrode 121, and the abundance of the particles 141 is lowered near the surface of the electrode 121. FIG. 15C is a schematic close-up view of the area near the electrode 121 shown in FIG. 15B. The negatively charged particle 141 moves away from the electrode 121 by receiving a repelling force 143 along electric field lines of the electric field 140 formed in the liquid.

A potential difference ΔV is expressed as Vc−Vh, where Vc is the potential of the opposing electrode 129, and Vh is the potential of the electrode 121 on the heat generating resistor 126 (heater) side, and the larger the potential difference ΔV (=Vc−Vh), the larger the repelling force acting on the particle 141. Thus, the larger the potential difference ΔV, the lower the abundance of the negatively charged particles 141, which can cause kogation, near the electrode 121; thus, the amount of kogation deposited is reduced.

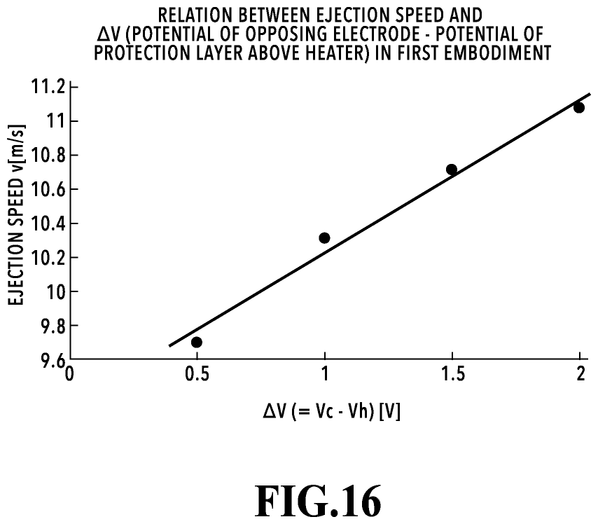

FIG. 16 is a graph showing the relation between the ejection speed and the potential difference ΔV. The ejection speed is inversely proportional to the amount of kogation deposited on the electrode 121; the higher the ejection speed, the less the kogation. The relation between the potential difference ΔV and the amount of kogation on the electrode 121 can be understood from the graph in FIG. 16 showing the relation between the potential difference ΔV and the ejection speed of the present embodiment. It is apparent from FIG. 16 that the larger the potential difference ΔV, the higher the ejection speed, and the larger the potential difference ΔV, the smaller the amount of kogation.

The above has described an example of ejecting ink containing a negatively-charged pigment. In contrast to this example, in a case of ejecting ink containing positively charged particles, voltage is applied to make the electrode 121 a positive electrode and the opposing electrode 129 a negative electrode. The abundance of the particles 141 that can cause kogation is thus lowered near the electrode 121, so that formation of kogation can be reduced.

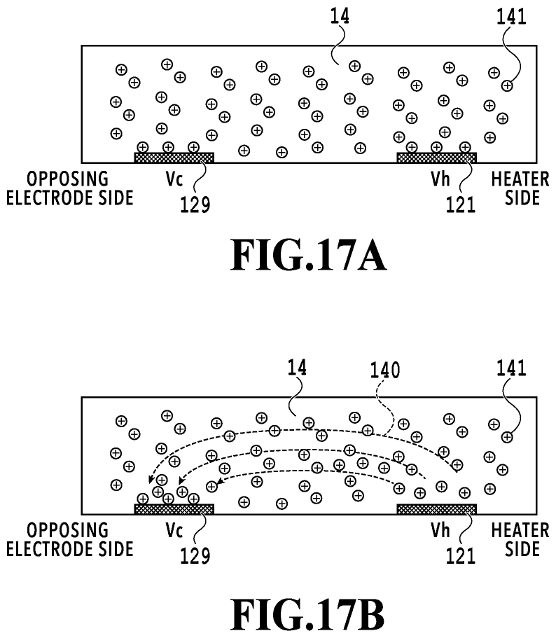

FIGS. 17A and 17B are schematic diagrams showing a kogation reduction process performed in a case where positively charged particles in the bubble formation chamber 14 are a dominant factor for kogation. As shown in FIG. 17A, the electrode 121 and the opposing electrode 129 are disposed in the bubble formation chamber 14, and the bubble formation chamber 14 is filled with liquid (ink). The liquid contains positively charged particles 141 of a pigment or the like, and the particles 141 are dispersed in the liquid substantially evenly with no voltage applied between the electrodes.

FIG. 17B shows a state where voltage is being applied to make the potential of the electrode 121 relatively higher than the potential of the opposing electrode 129. The difference in potential (in absolute value) between the electrode 121 and the opposing electrode 129 is preferably in the range of, for example, 0.5 V to 2.5 V. In this state, an electric field 140 is formed between the electrode 121 and the opposing electrode 129 via the liquid. Because the electrode 121 is charged positively relative to the opposing electrode 129, the positively charged particles 141 are repelled by the electrode 121, and the abundance of the particles 141 is lowered near the surface of the electrode 121. A process where a potential difference is generated between the electrode 121 and the opposing electrode 129 to move charged particles away from the electrode 121 is referred to as a kogation reduction process herein. The mechanism of such a kogation reduction process is described in, for example, Japanese Patent Laid-Open No. 2019-038127.

Also, the liquid ejection head is configured so that a kogation removal operation for removing kogation accumulated on the electrode 121 can be executed by performing potential control in the liquid ejection head. The kogation removal operation is an operation where voltage is applied (given) to make the electrode 121 an anode side and the opposing electrode 129 a cathode side. This operation removes kogation along with the protection film by electrochemically dissolving the electrode 121 in the liquid, thereby refreshing the superficial layer of the electrode 121 as good as new. The timing for performing the kogation removal operation may be managed by, e.g., counting the number of times ejection has been performed since the last kogation removal operation.

However, strictly speaking, a heater electrode in a brand-new liquid ejection head which has never performed the kogation removal operation and a heater electrode in a liquid ejection head which has performed the kogation removal operation before are not in the same state. Typically, the surface of a heater electrode is contaminated during a manufacturing process and is thus rather unclean in a brand-new state. By contrast, after kogation removal, the surface of the electrode 121 is not contaminated and is cleaner than the new state because the kogation removal operation has been performed by dissolving the upper protection layer 124.

Thus, in a brand-new liquid ejection head in which the surface of the electrode 121 is unclean, kogation deposition during an ejection operation may become unstable, and stable ejection characteristics may be unobtainable.

Thus, in the present embodiment, the potential differences ΔVa given between the electrode 121 and the opposing electrode 129 during ejection is different between a liquid ejection head in a brand-new state and a liquid ejection head which has performed the kogation removal operation. Specifically, in a brand-new liquid ejection head, the kogation reduction process is performed using a potential difference larger than that for a liquid ejection head which has performed the kogation removal operation before. For example, a potential difference ΔVa₁ between the electrode 121 and the opposing electrode 129 in a liquid ejection head which has performed the kogation removal operation before is in the range of 0.5 V to 2.4 V. By contrast, a potential difference ΔVa₂ between the electrode 121 and the opposing electrode 129 in a brand-new liquid ejection head is a value which is in the range of 0.5 V to 2.5 V and smaller than the potential difference ΔVa₁. As a result of this, the repelling force exerted from the electrode 121 to charged particles is made stronger for the brand-new liquid ejection head in order to lower the abundance of the charged particles near the electrode 121. As a result, a brand-new liquid ejection head can achieve ejection characteristics similar to those of a liquid ejection head which has performed the kogation removal operation before.

Note that conditions for potential control of the electrode 121 and the opposing electrode 129 in a liquid ejection head are desirably set to ones optimal for the ink. Thus, because the polarity with which particles in ink are charged differs depending on the type of the particles, it is desirable to apply voltage with the polarities of the electrode 121 and the opposing electrode 129 being changed depending on the type of the particles. Also, even with the same polarity, the number of particles contained in ink varies depending on the ink, and thus, the potential difference may be adjusted according to the number of particles (colorant's density).

In the present embodiment, the potential difference ΔVa between the potential of the electrode 121 and the potential of the opposing electrode 129 may be changed by changing the potential of one of the electrode 121 and the potential of the opposing electrode 129 or by changing both of them. However, a configuration in which the potential of one of the electrodes is changed to change the potential difference ΔVa can be achieved with a simpler circuit configuration and is therefore more advantageous in terms of costs. Also, as a different mode, with one of the electrodes fixed at GND, the other one of the electrodes may be changed according to conditions.

In this way, the potential difference given between the electrode 121 and the opposing electrode 129 for the kogation reduction process during ejection is different for a brand-new liquid ejection head and for a liquid ejection head which has performed the kogation removal operation before. Thus, a stable ejection operation can be performed irrespective of the state of the liquid ejection head.

### Second Embodiment

A second embodiment of the present disclosure is described below. Note that the basic configuration of the present embodiment is the same as that of the first embodiment; thus, the following describes only characteristic configurations.

In the case described in the first embodiment, after the kogation removal operation, the surface of the electrode 121 is cleaner than that in a brand-new state, and therefore kogation is less likely to form on the surface. However, the surface of the electrode 121 after the kogation removal operation may have kogation remaining thereon. In this case, the ejection characteristics may rather be more unstable than in a brand-new state.

In the present embodiment, in view of such circumstances, the kogation reduction process is performed using potential control conditions such that the potential difference ΔVa₂ is larger for a liquid ejection head having performed the kogation removal operation before than for a brand-new liquid ejection head. This makes it possible for a liquid ejection head having kogation remaining thereon to achieve ejection characteristics similar to those of a brand-new liquid ejection head.

Note that whether kogation remains on the surface of the electrode 121 after the kogation removal operation can be checked by performing ejection a small number of times so that the amount of kogation will not affect the ejection speed and inspecting the ejection characteristics (such as ejection speed). Thus, ejection may be performed with the kogation reduction process being performed under potential control suitable for how much kogation has been removed, which is inspected by ejection performed a small number of times so that the amount of kogation will not affect the ejection speed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-140029, filed Aug. 21, 2024 which is hereby incorporated by reference herein in its entirety.

What is claimed is:

1. A liquid ejection apparatus to which an ejection unit is attachable, the ejection unit having
a heat generating resistor configured to generate energy for ejecting liquid by generating heat upon energization,
a first electrode provided at a protection part covering and protecting the heat generating resistor, and
a second electrode capable of being electrically conductive to the first electrode via the liquid,
the liquid ejection apparatus comprising a control unit configured to control the ejection unit attached to the liquid ejection apparatus, wherein
by applying voltage between the first electrode and the second electrode, the control unit is capable of executing a kogation removal process for removing deposited kogation by dissolving a surface of the first electrode into the liquid, and
while the ejection unit performs a liquid ejection operation, the control unit generates a potential difference between the first electrode and the second electrode, the potential difference being different between a case where the ejection unit has performed the kogation removal process before and a case where the ejection unit has not performed the kogation removal process before.

2. The liquid ejection apparatus according to claim 1, wherein
while the ejection unit performs the liquid ejection operation, the control unit generates the potential difference between the first electrode and the second electrode, the potential difference being smaller for the case where the ejection unit has performed the kogation removal process before than for the case where the ejection unit has not performed the kogation removal process before.

3. The liquid ejection apparatus according to claim 1, wherein
the potential difference in the case where the ejection unit has performed the kogation removal process before is in a range of 0.5 V to 2.4 V, and
the potential difference in the case where the ejection unit has not performed the kogation removal process before is in a range of 0.5 V to 2.5 V.

4. The liquid ejection apparatus according to claim 1, wherein
the control unit sets polarities of the first electrode and the second electrode based on a type of the liquid.

5. The liquid ejection apparatus according to claim 4, wherein
in a case where the liquid contains negatively charged particles, the control unit applies the voltage to make the first electrode a negative electrode.

6. The liquid ejection apparatus according to claim 4, wherein
in a case where the liquid contains positively charged particles, the control unit applies the voltage to make the first electrode a positive electrode.

7. The liquid ejection apparatus according to claim 1, wherein
the control unit changes the potential difference given between the first electrode and the second electrode depending on a type of the liquid.

8. The liquid ejection apparatus according to claim 1, wherein
the control unit generates the potential difference between the first electrode and the second electrode, the potential difference being larger for the case where the ejection unit has performed the kogation removal process before than for the case where the ejection unit has not performed the kogation removal process before.

9. The liquid ejection apparatus according to claim 1, wherein
between the case where the ejection unit has performed the kogation removal process before and the case where the ejection unit has not performed the kogation removal process before, the control unit makes a potential of the first electrode different and a potential of the second electrode same.

10. A method for controlling a liquid ejection apparatus to which an ejection unit is attachable, the ejection unit having
a heat generating resistor configured to generate energy for ejecting liquid by generating heat upon energization,
a first electrode provided at a protection part covering and protecting the heat generating resistor, and
a second electrode capable of being electrically conductive to the first electrode via the liquid,
the method comprising a kogation removal step of applying voltage between the first electrode and the second electrode and removing deposited kogation by dissolving a surface of the first electrode into the liquid, wherein
while the ejection unit performs a liquid ejection operation, a potential difference is generated between the first electrode and the second electrode, the potential difference being different between a case where the ejection unit has performed the kogation removal step before and a case where the ejection unit has not performed the kogation removal step before.

11. The method for controlling a liquid ejection apparatus according to claim 10, wherein
the liquid is ejected with polarities of the first electrode and the second electrode being set based on a type of the liquid.

12. The method for controlling a liquid ejection apparatus according to claim 11, wherein
in a case where the liquid contains negatively charged particles, the voltage is applied to make the first electrode a negative electrode.

13. The method for controlling a liquid ejection apparatus according to claim 11, wherein
in a case where the liquid contains positively charged particles, the voltage is applied to make the first electrode a positive electrode.
